(19) United States
(12) Patent Application Publication
(10) Pub. No.: US 2016/0101565 A1
(43) Pub. Date: Apr. 14, 2016

(54) METHOD OF 3D PRINTING USING ROTATIONAL POSITIONING AND STARTER SUBSTRATE

(71) Applicant: HON HAI PRECISION INDUSTRY CO., LTD., New Taipei (TW)

(72) Inventors: EDWARD JOHN VAN LIEW, Santa Clara, CA (US); ERNEST DALE JENKINS, Santa Clara, CA (US); JOSEPH ALAN WOLFMAN, Santa Clara, CA (US)

(21) Appl. No.: 14/509,606

(22) Filed: Oct. 8, 2014

(51) Int. Cl. B29C 67/00

(52) U.S. Cl. CPC B29C 67/0055; B29L 2031/772

(57) ABSTRACT

A method of printing a three dimensional object in three dimensions using a starter substrate and rotational positioning is provided. The three dimensional printing method includes obtaining a starter substrate, coupling the starter substrate onto a rotating spindle, rotating the starter substrate about a rotational axis of the rotating spindle, and depositing material onto the starter substrate.

### FIELD

The subject matter herein generally relates to 3D printing and specifically a method of 3D printing using a starter substrate and rotational positioning.

### BACKGROUND

3D printing is a quickly growing segment for inventors and tinkerers. The existing machines are very slow and expensive. Current consumer 3D printers start at a plane “Z”=0 and build the product in all 3 axes until the finished product at “Z” height is complete. For solid objects, most of the printed portion is not visible to a user and is just “filler” for support and stability to arrive at the end product, adding to excess cost and manufacturing time.

### BRIEF DESCRIPTION OF THE DRAWINGS

Implementations of the present technology will now be described, by way of example only, with reference to the attached figures, wherein:

FIG. 1 is an illustration of a first stage in one embodiment of 3D printing using a starter substrate and rotational positioning.

FIG. 2 is an illustration of a second stage in one embodiment of 3D printing using a starter substrate and rotational positioning.

FIG. 3 is an illustration of a final stage in one embodiment of 3D printing using a starter substrate and rotational positioning.

FIG. 4 is a diagrammatic flowchart of an embodiment of a method of printing an object in 3D.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a 3D printing method utilizing a starter substrate 100, and a rotational and scanning material deposition process.

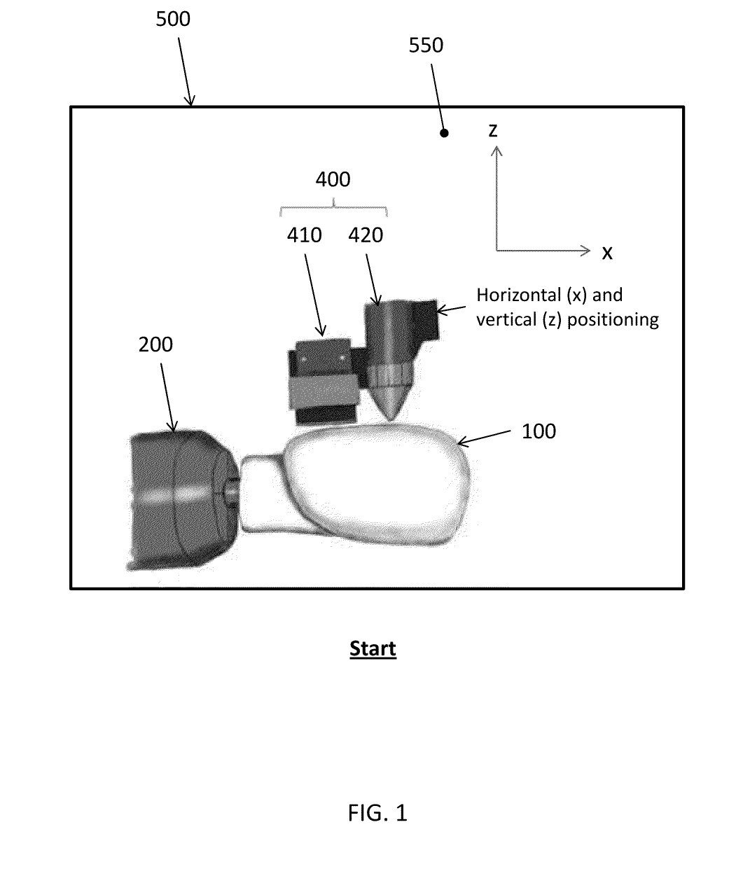

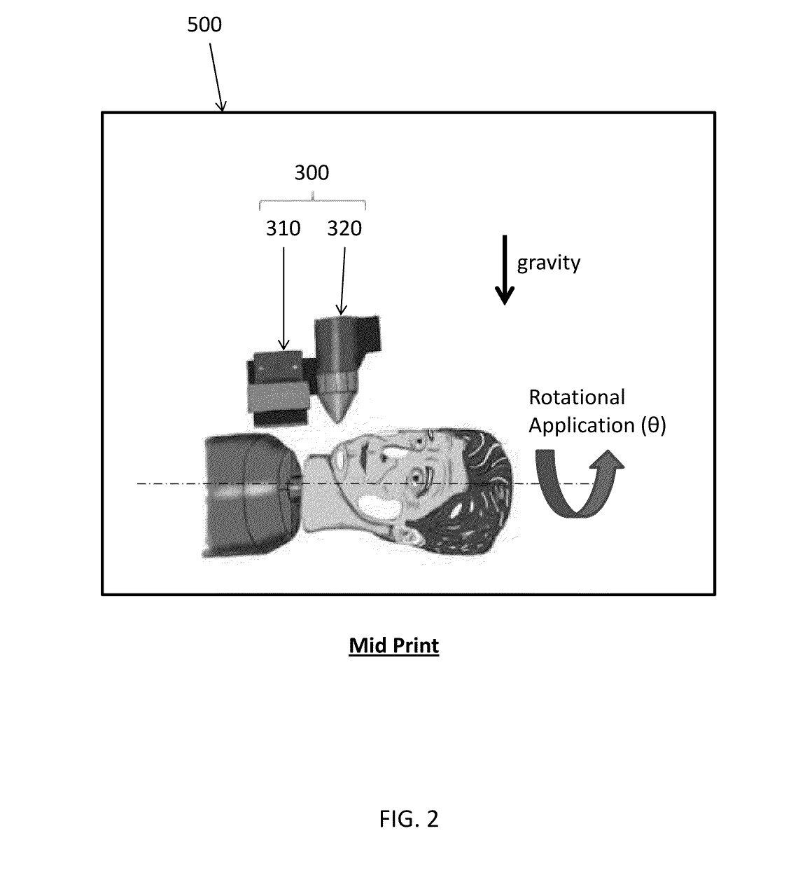

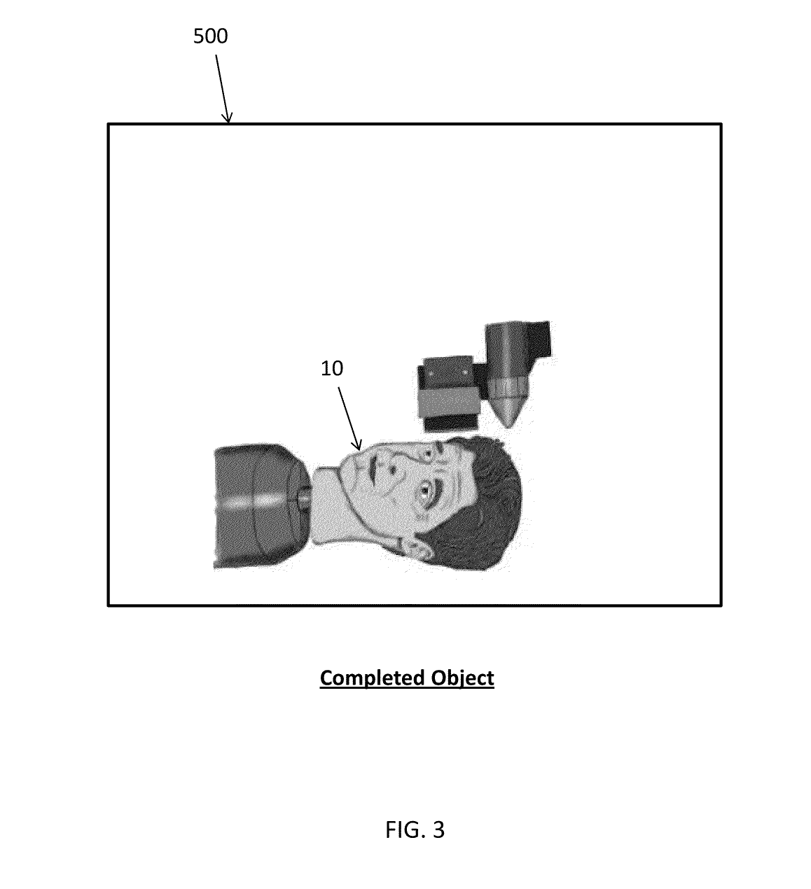

FIGS. 1-3 illustrates an embodiment of a first stage (FIG. 1), a second stage (FIG. 2), and a final stage (FIG. 3), of a 3D printing method for forming a 3D printed object 10 using a starter substrate 100 and rotational positioning. The 3D printing can be accomplished by an additive process. Material 300 can be extruded through a 3D printing device 400 and deposited on the starter substrate 100 layer upon layer to form the 3D printed object 10. The 3D printing station includes a chamber 550, and a 3D printing device 400 and a spindle 200 housed in the chamber 550. The 3D printing station can be printed

The starter substrate 100 is coupled to a rotating spindle 200 and can be placed beneath the 3D printing device 400. The starter substrate 100 can have an identification code indicating a type of starter substrate 100 for the 3D printing device 400 to print. Each starter substrate 100 can have a different identification code depending on characteristics of the starter substrate 100. For example, one starter substrate 100 can be a ring, another a head, and each will have a different identification code. The identification code can aid in automating the 3D printing device 400 and can allow adjustments to give options for the 3D printed object 10 such as color or features.

The 3D printing device 400 extrudes material 300 onto the starter substrate 100 at different positions on the starter substrate 100. The material 300 can be mass placement 320 housed in the extruder 420 of the 3D printing device 400 and/or colorant 310 housed in the color applicator 410 of the 3D printing device 400. The 3D printing device 400 can move along a direction x substantially parallel to a rotation axis of the rotating spindle 200, the rotating spindle 200 can move along the rotation axis, or both. The 3D printing device 400 can also move along a direction z substantially perpendicular to the rotation axis. This allows the material 300 to be deposited over some or the entire starter substrate 100 at different positions while the starter substrate 100 is rotating or fixed.

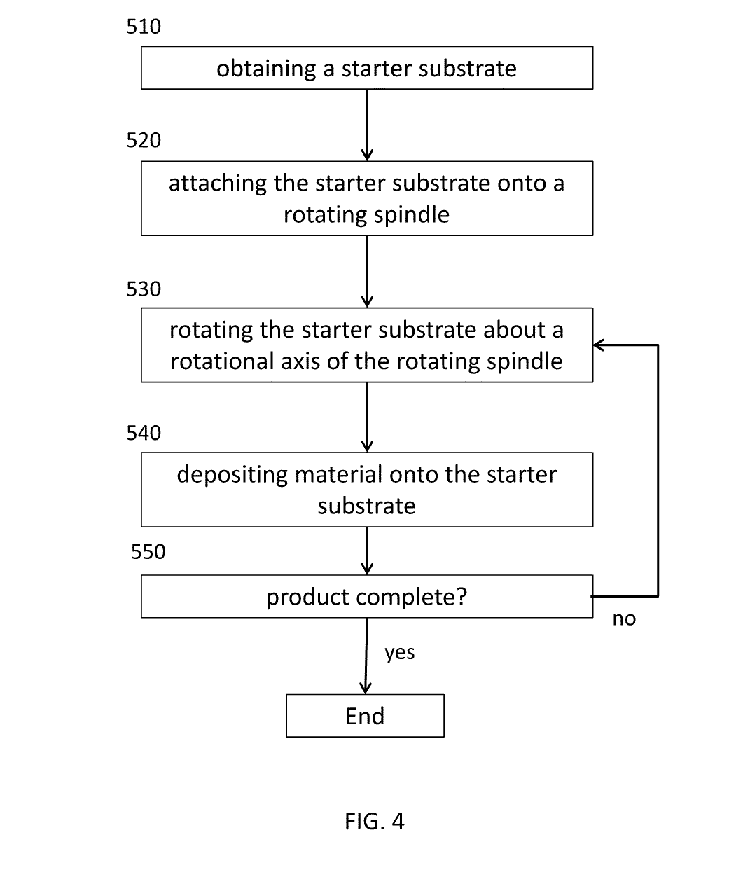

FIG. 4 illustrates a flowchart of an embodiment of a method of printing an object 10 in 3D. The method is provided by way of example, as there are a variety of ways to carry out the method. The method described below can be carried out using the configurations illustrated in FIG. 1, for example, and various elements of these figures are referenced in explaining the method. Each block shown in FIG. 4 represents one or more processes, methods or subroutines, carried out in the method. Furthermore, the illustrated order of blocks is illustrative only and the order of the blocks can change according to the present disclosure. Additional blocks can be added or fewer blocks may be utilized, without departing from this disclosure. The method can begin at block 510.

In block 510, the starter substrate 100 is obtained. The starter substrate 100 can be any shape and has a defined geometry. The starter substrate 100 serves as the bulk of the unseen object. In one embodiment, the starter subject 100 is symmetrical. The method continues to block 520.

In block 520, the starter substrate 100 can be attached to a rotating spindle 200. The method continues to block 530.

In block 530, the starter substrate 100 can be rotated about the rotational axis of the rotating spindle 200, if necessary. The rotational axis of the rotating spindle can be horizontal or substantially perpendicular to the direction of gravity. The starter substrate 100 can be rotated in a clockwise direction, a counterclockwise direction, or both directions by the rotating spindle 200. The rotating spindle can also be moved in and out along the rotation axis. The block continues to block 540.

In block 540, material 300 is deposited on the starter substrate 100 at a position on the starter substrate 100 after the rotating spindle 200 has rotated the starter substrate 100 to a desired position or while the rotating spindle 200 is rotating the starter substrate 100. The material 300 deposited can be a mass placement and/or a colorant. The 3D printing device 400 can be used to deposit the material 300 onto the starter substrate 100. The 3D printing device 400 can be configured to move along a direction substantially parallel to the rotation axis and substantially perpendicular to the rotation axis. Thus, the rotation spindle 200, the 3D printing device 400, or both can move along a direction substantially parallel to the rotation axis. The 3D printing device 400 comprises a color applicator 410 housing the colorant 320 and an extruder 420. The method continues to block 550.

In block 550, if the 3D printed object 10 is complete, the method ends. Otherwise, the process returns to block 530 and the process continues until the 3D printed object 10 is complete. The material 300 deposited on the starter substrate 100 can be about 50% or less than the total volume of the 3D printed object 10, such as less than 20%.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method of printing a 3D printed object, the method comprising (a) depositing material onto a starter substrate.

2. The method of claim 1, wherein the starter substrate has a defined geometry.

3. The method of claim 1, further comprising:
(b) rotating a starter substrate about a rotational axis of a rotating spindle before or after step (a); and
(c) repeating steps (a) and (b) until formation of the 3D printed object is complete.

4. The method of claim 3, wherein the rotating spindle is configured to rotate the starter substrate in at least one direction.

5. The method of claim 4, wherein the rotating spindle is configured to rotate the starter substrate in a clockwise and counterclockwise direction.

6. The method of claim 5, wherein the rotating spindle is further configured to move in and out along the rotation axis.

7. The method of claim 5, wherein the rotational axis is substantially perpendicular to the direction of gravity.

8. The method of claim 5, wherein the material is deposited onto the starter substrate as the starter substrate is rotated into a desired position or while the starter substrate is rotating.

9. The method of claim 5, wherein the material deposited is 50% or less than the total volume of the 3D printed object.

10. The method of claim 5, wherein the material deposited is at least one of mass placement and colorant.

11. The method of claim 10, wherein a printing device deposits the material onto the starter substrate, and the printing device is configured to move along a direction substantially parallel to the rotation axis and substantially perpendicular to the rotation axis.

12. The method of claim 11, wherein the printing device comprises a color applicator housing the colorant and an extruder housing the mass placement.

13. The method of claim 2, wherein the starter substrate has an identification code indicating a type of the starter substrate for the 3D printing device to print.

14. A 3D printing station for printing a 3D object using a starter substrate, the 3D printing station comprising a chamber and a printing device housed in the chamber, the printing device comprising an extruder housing material, wherein the printing device is configured to extrude the material onto the starter substrate to form the 3D object.

15. The 3D printing station of claim 14, wherein the material deposited is at least one of mass placement and colorant.

16. The 3D printing station of claim 15, wherein the starter substrate has an identification code indicating a type of the starter substrate for the 3D printing device to print.

17. The 3D printing station of claim 14, wherein the material deposited is 20% or less than the total volume of the 3D printed object.

18. The 3D printing station of claim 14, further comprising a rotating spindle coupled to the starter substrate, wherein the rotating spindle rotates the starter substrate into a desired position.

19. The 3D printing station of claim 18, wherein the rotating spindle is further configured to move in and out along the rotation axis.

20. The 3D printing station of claim 18, wherein the printing device is configured to move along a direction parallel to the rotation axis and substantially perpendicular to the rotation axis.
